(19) United States
(12) Patent Application Publication
(10) Pub. No.: US 2002/0042815 A1
(43) Pub. Date: Apr. 11, 2002

(54) Automated system and method for routing undeliverable e-mail messages and otherwise managing e-mail

(76) Inventors: Arthur Salzfass, Chappaqua, NY (US); Charles Palanzo, Brookfield, CT (US); Arthur Levitan, Wilton, CT (US)

Correspondence Address: DARBY & DARBY P.C., 805 Third Avenue, New York, NY, 10022, US

(21) Appl. No.: 09/956,750

(22) Filed: Sep. 19, 2001

Related U.S. Application Data
(60) Provisional application No. 60/234,554, filed on Sep. 22, 2000.

(30) Foreign Application Priority Data
Sep. 22, 2000 (JP) 2000-287966

(51) Int. Cl. G06F 15/16

(52) U.S. Cl. 709/206

(57) ABSTRACT

An improved system and method are provided for routing an otherwise undeliverable e-mail message to an intended recipient as a part of a full-featured, integrated, user-preference driven (1) automatic, reactive, and (2) proactive, user initiated e-Mail Management System using characteristics of the e-mail process, including addressing, content, distribution, and error messages.

### FIELD OF THE INVENTION

The invention relates generally to the field of electronic mail (e-mail) and, more particularly, to a system and method for routing undeliverable e-mail messages, a proactive system and method for determining the routing of e-mail messages and otherwise managing e-mail by using various characteristics of the entire e-mail process, including addressing, content, distribution, content of error messages and the personal and business needs of the users.

### BACKGROUND OF THE INVENTION

The past several years have seen a dramatic proliferation of electronic office systems. The proliferation of such systems has created a need for improved systems and methods for exchanging and storing information. Electronic mail networks permit a network of communicating users to transmit documents (e.g., text, graphics, etc.) from one user to another user. More specifically, these networks facilitate the transfer of electronic mail messages, otherwise known as e-mails. An e-mail item generally is formed of three components, namely (1) a body portion, (2) one or more attachments, if included and (3) attributes. The body is either the entirety of the message or the equivalent of a cover letter for the attachments. An attachment is any stand-alone file containing information the sender is attempting to communicate (a text document, a presentation, an image, a video, a spreadsheet, etc.). The attributes are typically presented in a header section of the e-mail. The specific attributes set forth in the e-mail can vary from one system to another; however, the attributes typically include such things as the identification of one or more recipients (the addresses), the date the e-mail message was created, the time that the message was sent, the sender or originator (including the electronic address thereof), a title or name for the message, and other information about the document that the recipient may be interested in. One of the difficulties associated with electronic message networks is that people periodically change their electronic mail addresses. This may result for any number of reasons, including that a personal electronic address has been intentionally changed or a workplace electronic address for the individual has changed. For example, many people have several personal electronic addresses and over time may decide to consolidate their personal electronic addresses into one preferred electronic address. Furthermore, most individuals have a workplace electronic address that in today's marketplace is also subject to periodic change due to workers frequently changing jobs. Thus, the electronic workplace address of the individual will also change as the individual begins employment at a new entity. This phenomena is not just limited to individuals, in that, a corporate entity or the like may merge or otherwise be consolidated with another entity. This will likely impact the electronic addresses of each and every employee of one or more of the corporate entities. In addition, a corporate entity may undergo a corporate name change and thus the electronic addresses of the employees can change to reflect the new corporate name. These are merely exemplary situations illustrating that electronic addresses for a given individual, or even a corporate entity, are subject to change.

When a sender attempts to send an e-mail to an electronic address that has been changed or is otherwise not in existence, the sender ordinarily receives an electronic error message from a mail delivery subsystem which indicates that the e-mail message has not been delivered. This message can list the address that was undeliverable and also provide further information concerning the specific reasons the sender's e-mail could not be delivered. The mail subsystem may also indicate that after numerous attempts it failed to find a valid destination for the message. For example, when a designated domain name cannot be accessed or an electronic mailbox at that domain cannot be located, the message will indicate that the recipient mailbox was not found and therefore the address constituted one of an undeliverable nature. It should be noted that in some instances no error message or response of any kind is returned.

More specifically, one conventional manner of producing and sending an e-mail message is to use an e-mail client program (mail client) which combines the functionality of a text editor with a messaging system. Delivery is solely dependent on the e-mail message's destination address. This address is comprised of two distinct and functionally different parts, namely the address name and the domain. The domain portion of the address is the functional equivalent of a “zip code” and allows the message to be sent to a specific mail server that is responsible for receiving and storing mail messages for a number of mail clients. The name portion of the address permits the receiving mail server to correctly store the message for retrieval from the particular mail program of the receiver. Typically, the messages are stored at the receiver's mail server until the receiver's e-mail program requests the messages. Some receiver e-mail programs are designed so that the program requests and retrieves mail regularly.

In the conventional transmission of an e-mail message, the sender's e-mail client transmits the message to the sender's outgoing mail server. Before the outgoing server can send the message to its destination it must obtain an actual Internet protocol (IP) address for the recipient's incoming mail server. In other words, the domain portion of the address must be converted into an IP address. In order to obtain the correct IP address for the requested domain, the outgoing mail server communicates with a domain name server (DNS). The DNS will either respond with a destination IP address for the domain's mail server or it will respond that the domain cannot be found. This is a first type of addressing error that can cause a message to be undeliverable (“bad domain error”). In the case of a bad domain error, the sender's outgoing mail server will typically construct an error message and deliver it to the sender's incoming mail server. No further attempt will be made to transmit the original message. The sender will not know that there has been a problem until the sender requests and accesses his/her messages from his/her incoming mail server.

Once the sender's outgoing mail server receives a valid IP address from the DNS, it can and does transmit the message across the Internet to the recipient's incoming mail server. This incoming mail server must then validate the name in the address field. If the name does not exist within that domain, then the recipient's incoming mail server typically causes an error message to be sent from the recipient's outgoing mail server to the sender's incoming mail server to inform the sender that the “person” does not exist at that domain. This is the second type of addressing error that causes a message to be undeliverable. For the purpose of illustration and simplicity, this type of error is referred to as a “bad name error”. Once again the sender will not know this until he/she retrieves his/her mail from the sender's incoming mail server. If the recipient's incoming mail server correctly validates the name in the address field of the message, then the message is stored in a specific location until the recipient retrieves it. This is a successful delivery.

Conventionally, an individual or an entity could take one or more actions in an attempt to assure continuity of e-mail delivery in the event of a change of e-mail address. These actions have proven largely unsuccessful for a number of reasons. One method is to directly notify specific individuals and entities of the change in one's e-mail address. This can become very costly and time consuming and in addition is not very effective because some of the target individuals and/or entities may be unreachable due to a number of circumstances. The disadvantages of this direct notification method are especially profound when dealing with corporate e-mail accounts. For example, an individual or an entity cannot know the universe of those who will seek to contact them (merchants, government, etc.). The entities that are supposedly known could also have obsolete addresses. Furthermore, the nonselective broadcasting of the address change to entities included in an address list could result in contacting entities who are no longer interested in having the new e-mail address or entities who should not be forwarded the new address because of personal preference.

Another method to ensure continuity is to keep the old e-mail address active for a predetermined period of time. Thus, there is an overlap between the old account and the new account for as long as possible or desirable. Once again this is rather costly and not especially effective due to administrative details. For example, if an employee changes jobs, the employee's old corporate e-mail address is likely to be deleted immediately. In this situation, there is effectively no overlap between the employee's old corporate e-mail account and a new corporate e-mail account at a new place of employment. Furthermore and in any event, the employee is unlikely to be able to gain access to the old corporate e-mail account since the employee is no longer part of the corporation.

Another method to try and insure continuity is the posting of the new e-mail address in an online database for search and retrieval. While similar in nature to the global e-mail database discussed within this patent, the current implementations are ineffective because they a) require a sender to know of the databases existence and manually initiate a search and b) are limited in scope and are programmatically updated infrequently if at all.

Another method is the distribution of an advertisement that lists the new e-mail address. The advertisement may be sent via multiple venues, including but not limited to print, web sites, business cards, etc or by some combination thereof. The disadvantages of advertising are cost and effectiveness.

Thus, there is a need for an improved system and method which makes it possible for an individual, institution or corporate entity to receive e-mail that would otherwise be lost (undeliverable type) from unspecified senders after the intended recipient's e-mail address has changed or becomes invalid or out of date. The present invention satisfies these and other needs.

### SUMMARY OF THE INVENTION

An improved system and method are provided for routing an otherwise undeliverable e-mail message to an intended recipient by automatically and proactively interpreting the content of the resultant error message. In addition, the system can be invoked by the user at any time to determine the most current e-mail address of a potential recipient without waiting for an error message. The system may optionally be configured so that at predetermined intervals, the system determines the most current e-mail address without requiring user intervention.

The present system provides two different methods for solving the undeliverable e-mail problem:

1. “Reactive Method”—Automatically interprets and acts upon the receipt of mail subsystem error messages; and

2. “Proactive Method”—Can be configured to pre-check the address and correct the message before it is transmitted to the recipients mail system.

The present system contains a global e-mail address database and e-mail forwarding server [DB+FS]. The DB+FS includes a list of invalid e-mail addresses and a list of corresponding current, valid e-mail addresses for each of the invalid e-mail addresses. The global database is designed so that an individual or entity, in this case the intended recipient, can cause a no longer valid e-mail address to be entered along with a preferred valid e-mail address. The system involves a manually elected or automatic comparison of the invalid e-mail address with the global database and if a match is found, the system then reads the preferred e-mail address and will forward the initial e-mail message to the intended recipient at this preferred e-mail address under the select conditions.

Generally speaking and according to one embodiment, an initial e-mail message is electronically mailed from a first machine associated with a sender to an initial e-mail address of the intended recipient at a second machine associated with the intended recipient. Currently, in the event that the e-mail message contains an undeliverable recipient address, an error message is generated and returned to the sender's computer. The system exists physically and/or logically in any of several locations along the message path. The system reacts to and parses each reply error message to determine whether the initial e-mail address is still valid, i.e., whether the domain is good and/or the intended recipient is known. In some instances, these error messages will not contain specifics of the error but are used to trigger the intervention process of the system. The present system does not require specific error reasons to be included in order for the system to function.

The error message typically lists the reasons why there was a failed delivery: the intended e-mail recipient could not be located (“bad name” error) or where the DNS does not find a valid domain (“bad domain error”). In the event that either part of the initial e-mail address is no longer valid, the initial e-mail message is forwarded to the DB+FS by the present system. The initial e-mail message is then processed at the DB+FS in accordance with at least one prescribed criterion. The present system contains multiple embodiments in which, because an error was generated, the initial e-mail message and in some cases subsequent error messages and events are processed in a variety of ways and, under select conditions, the initial e-mail is delivered to the intended recipient at a different, valid e-mail address.

For example, if the invalid e-mail address is included in the database of the DB+FS, the DB+FS will send an e-mail notification to the preferred e-mail address indicating that an e-mail (the initial e-mail) has been mis-addressed to an old account. The intended recipient is then given the option of requesting that the initial e-mail be re-delivered to the newer, preferred e-mail address. If the intended recipient elects to receive the initial e-mail, it will be delivered to the preferred e-mail address and optionally, the sender will be notified of the preferred e-mail address for future mailing actions.

There are number of option settings that can be entered into the DB+FS for altering how and when the initial e-mail is delivered to the intended recipient at the second machine. For example, the intended recipient may enter an automatic forwarding setting, whereby all e-mails are automatically forwarded to the preferred e-mail address or the intended recipient may enter a screening list into the DB+FS so that the DB+FS effectively screens the initial e-mails before contacting the intended recipient.

The present system thus overcomes the deficiencies associated with the conventional methods of attempting to provide continuity of e-mail delivery. The present system is more cost effective and less complicated than prior attempts to apprize individuals and entities of a change of e-mail address.

In the present system, a designated e-mail forwarding server is configured to act not only as a global data base server (DB+FS) but also as an engine for performing the many functions described herein in connection with the present system. This server also provides the basis for several other features that, in conjunction, make up a total e-Mail Management System (FIG. 7). This e-Mail Management System has three broad categories: undeliverable e-mail, filters and services. Included in the total e-Mail Management System are the system disclosed herein and a proactive and automated system and method for:

Virus screening/cleaning/rejection

“SPAM” protection (individual names, words, bulk mailings, etc)

Forwarding to temporary mail boxes

Sender anonymity

Recipient anonymity

Translations to other languages

Text to speech for pager & cell phone

Braille machines, etc.

Corporate management of Internet traffic which could be used to prevent personal use among other things

Metrics and activity (usage) reports

A list of possible domain name variations that have already been checked for validity from which the sender may choose

Other features and advantages of the present invention will be apparent from the following detailed description when read in conjunction with the accompanying drawings.

### BRIEF DESCRIPTION OF THE DRAWINGS

FIG. 1 illustrates one exemplary network arrangement of hardware and software components for transmitting e-mail messages;

FIG. 2 illustrates a network arrangement of hardware and software components for implementing a method in accordance with one exemplary embodiment of the present invention;

FIG. 3 illustrates a process flow for receiving an electronic message of an undeliverable type according to one embodiment;

FIG. 4 illustrates a process flow for receiving an electronic message of the undeliverable type according to another embodiment;

FIG. 5 illustrates a process flow of additional steps for use in the process flow of FIG. 3;

FIG. 6 illustrates a process flow for receiving an electronic message of the undeliverable type and then anonymously replying thereto according to yet another embodiment; and

FIG. 7 provides an overview of the total e-Mail Management System.

### DETAILED DESCRIPTION OF THE PREFERRED EMBODIMENTS

Normal delivery of e-mail:

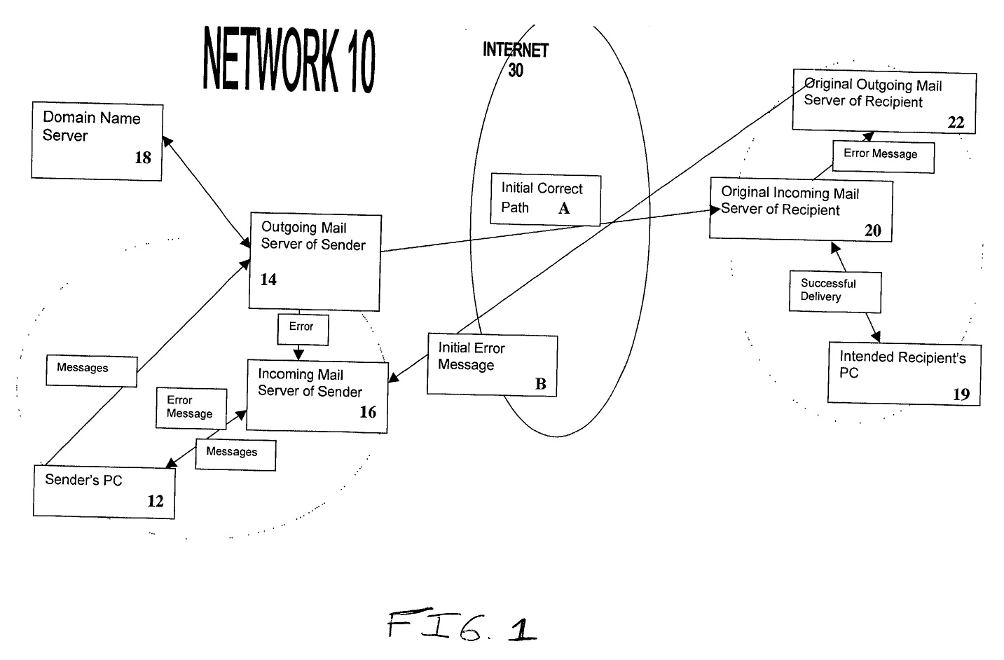

FIG. 1 illustrates a network arrangement (system), generally indicated at 10. The network 10 includes a first client (sender) machine 12 that is used by a first user, also referred to herein as a sender. The first client (sender) machine 12 in turn communicates with an outgoing e-mail server 14 and an incoming e-mail server 16. The first client (sender) machine 12 typically includes an e-mail system that permits the construction and transmission of e-mail messages. For purposes of illustration only, the first user (sender) maintains an e-mail account with a personalized e-mail address at the outgoing e-mail (sender) server 14. The outgoing e-mail (sender) server 14 in turn communicates over a communication link to other servers commonly connected to a distributed computer network such as the Internet 30. In certain cases, the outgoing e-mail (sender) server may determine that the intended recipient is “local” and only needs to communicate with the incoming e-mail server 16. In lieu of the Internet 30, communications can be through an Intranet or extranet or between a host computer and a kiosk located nearby, or by any other means of communication, electronically or otherwise, that can be implemented as understood by those of skill in the art. The outgoing e-mail (sender) server 14 is configured to convey messages from the first user (sender) through the Internet 30. Once a message is constructed and transmitted, the message is delivered to the outgoing e-mail server 14. The outgoing e-mail server 14 is in communication with an existing domain name server (DNS) 18 which serves to provide a destination IP address for the domain's mail server (defined in the message) or to respond that the domain cannot be found.

If the DNS 18 locates and responds with a destination IP address for the domain's mail server, the outgoing mail server 14 transmits the message across the Internet to a recipient's incoming e-mail server 20. The incoming mail server 20 then attempts to validate the name in the address field. If the name is validated, a successful e-mail delivery is made to a second client (recipient) machine 19. In the illustrated FIG. 1, the outgoing e-mail (sender) server 14 is shown and will be described herein as being a dedicated e-mail server which communicates with the first client (sender) machine 12 through any conventional means. It will be appreciated by one of skill in the art that the outgoing e-mail (sender) server 14 may actually comprise a portion of another server or the first client (sender) machine 12. In addition, it will be understood that the outgoing e-mail (sender) server 14 may include the outgoing mail server 14 and incoming mail server 16 (shown in FIG. 1). In other words, the outgoing e-mail (sender) server could be designed to transmit and receive e-mail. Also, groups of computers, sometimes known as “clusters”, acting in concert, can be used to implement any of the server functions described here.

The network 10 also includes a second client (recipient) machine 19 that is used by a second user (recipient), also referred to herein as an intended recipient. The second client (recipient) machine 19 preferably includes a communication link to the Internet 30.

What can go wrong:

When the domain cannot be found, the outgoing e-mail server 14 receives notification from the DNS 18 that the domain is unknown and then the outgoing e-mail server 14 constructs an error message (bad domain message) and delivers it to the sender's incoming e-mail server 16. The message then remains there until the sender retrieves it and decides to take some action. The current systems are not automated or proactive and make no attempt to interpret the error or solve the delivery problem.

If the message is transmitted through to the recipients incoming e-mail server 20, but the name is not validated, then an unsuccessful e-mail delivery results and a recipient's incoming e-mail server 20 transmits an error message to the recipients outgoing e-mail server 22 which transmits an error message (bad name message) to the sender's incoming mail server 16 for action.

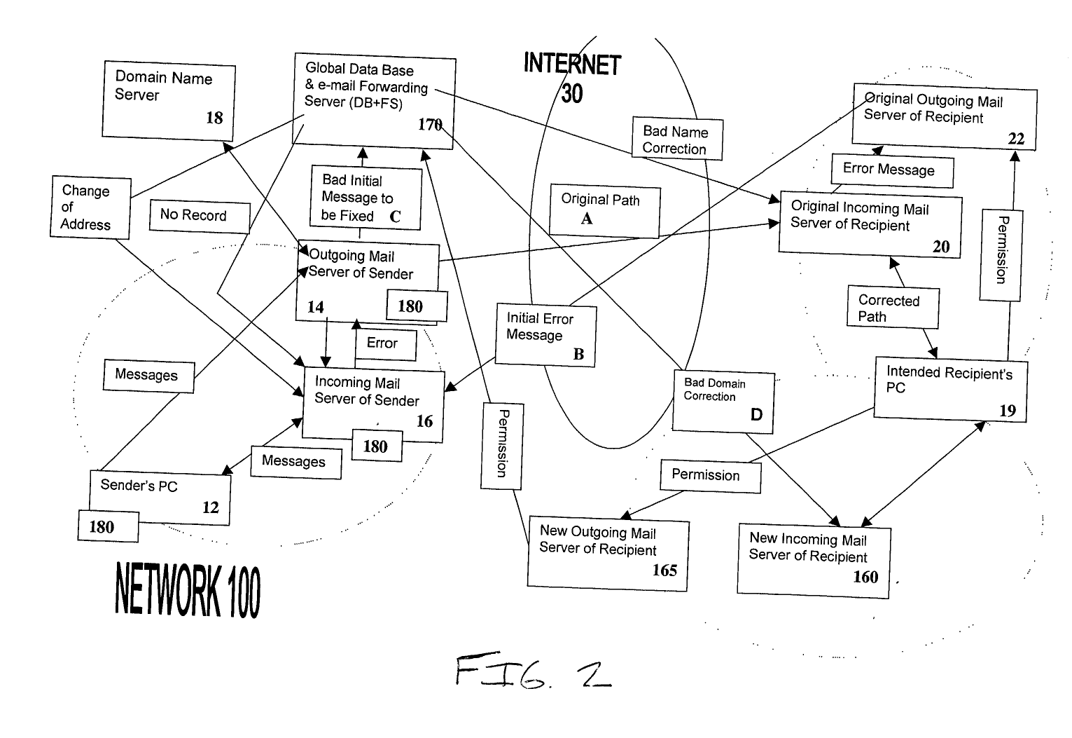

FIG. 2 illustrates a network arrangement (system), generally indicated at 100, by which an otherwise undeliverable e-mail message is routed to an intended recipient according to one exemplary embodiment. In the first instance, the intended recipient machine 19 of FIG. 1 previously but no longer communicates with the electronic e-mail server 20 because there is a “bad domain” error. In the second instance, the domain is still valid, and there is only a “bad name” error so the intended recipient machine 19 continues to communicate with the e-mail server 20.

Previously, the second user (recipient) maintained an e-mail account with a personalized e-mail address at the original e-mail server 20. For any number of reasons, this prior e-mail account is no longer active and therefore the personalized e-mail address is invalid. For example, the second user (recipient) may have closed this account in favor of another account or in another example, the account was closed because the user no longer works for a particular employer who maintained this personalized e-mail address for use during the course of employment.

Instead, the second client (recipient) machine 19 communicates with a third electronic mail (e-mail) server 160 referred to hereinafter as a current (new) incoming e-mail server (recipient) 160. For purposes of illustration only, the second user (recipient) maintains an e-mail account with a personalized current e-mail address at the current (new) incoming e-mail server (recipient) 160. In the illustrated embodiment, the current, incoming e-mail server 160 and its companion outgoing e-mail server 165 are shown and will be described herein as being a dedicated e-mail server in operative communication with the second client (recipient) machine 19. The current, incoming e-mail server 160 and its companion outgoing e-mail server 165 are configured to convey messages to and from the second user (recipient) through software that runs at one respective second client (recipient) machine 19.

The network 100 also includes a designated data base and e-mail-forwarding server (hereinafter DB+FS) 170 which communicates with the outgoing e-mail (sender) server 14 and the current (new) incoming e-mail server (recipient) 160 through the Internet 30 and which is designed to route e-mails from any number of other servers connected to the Internet 30. According to the present invention a software module, generally indicated at 180, which facilitates the routing of an otherwise undeliverable e-mail message exists at either first client (sender) machine 12 (sender's PC or its browser), the outgoing e-mail (sender) server 14 and/or the incoming e-mail (sender) server 16 or other places in the message path. The first and second client (recipient) machines 12, 19 can assume a variety of forms, including a personal computer, a personal digital assistant, a pager, an Internet compliant telephone, other electronic or Internet compliant device.

Preferably, the module 180 is located within the incoming mail server 16 when the present invention is practiced according to the reactive embodiment. In a proactive embodiment, the module 180 is preferably located within the outgoing mail server 14. Preferably, the module 180 comprises software that is functionally compatible with both servers 14, 16. It will therefore be understood, that to a simple user of a “mail” system, both servers 14, 16 are accessed.

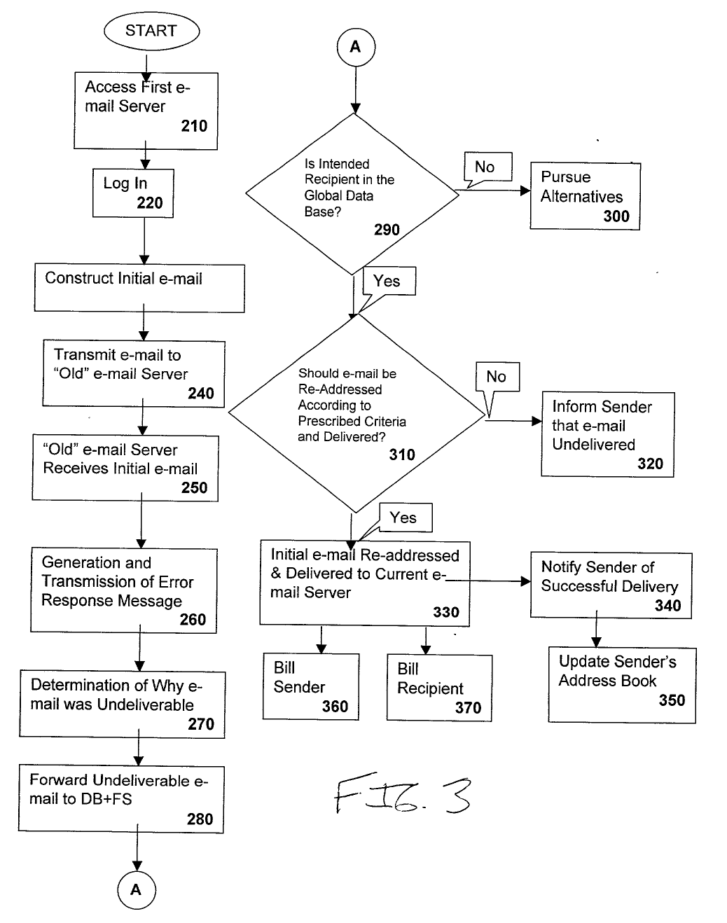

FIG. 3 is a process flow that illustrates a method of routing an otherwise undeliverable e-mail message according to one embodiment of the present invention and is discussed in conjunction with FIGS. 1 and 2. At step 210, the first user accesses the outgoing e-mail (sender) server 14 in any conventional manner using the first client (sender) machine 12. The e-mail client program of the first client (sender) machine 12 is used to construct the e-mail message. Through the use of cookies or similar technology, the outgoing e-mail (sender) server 14 may be able to discern whether the first user has previously accessed the outgoing e-mail (sender) server 14. This way, any customized preferences or other information stored will be recalled. If so, no login steps are required. Otherwise at step 220, the first user logs into the outgoing e-mail (sender) server 14. Typically, when the first user logs into the outgoing e-mail (sender) server 14 using a password or the like. A request to the outgoing e-mail (sender) server 14 will call up and present the e-mail account of the first user and, among other things, indicate if any e-mail messages have arrived since the first user last accessed the outgoing e-mail (sender) server 14.

At step 230, the first user (sender) constructs an e-mail message using the e-mail client program. Typically, the construction of an e-mail message includes combining an e-mail address of an intended recipient with a message. Optionally, a title or subject is included along with the content of the message. The e-mail address of the intended recipient provides the outgoing e-mail (sender) server 14 with routing instructions as to where to attempt to deliver the e-mail. As previously mentioned, the e-mail address is formed of a name address portion and a domain portion. For the purpose of illustration of the present invention, the sender enters a prior or defunct e-mail address of the second user (recipient) (intended recipient). Thus, for purposes of illustration, the domain portion of the address is correct. It is therefore understood that the outgoing e-mail (sender) server 14 has confirmed the domain portion of the address with the DNS 18 (FIG. 1) and an IP address has been furnished. In other words, the sender addresses the recipient by way of the original e-mail server 20. At step 240, the outgoing e-mail (sender) server 14 (outgoing e-mail server thereof) transmits the e-mail to the original e-mail server 20 through the Internet 30, as represented by arrow A. This transmission is made using standard Internet mail protocols (e.g., SMTP).

At step 250, the original e-mail server 20 receives and attempts to deliver the e-mail to the prior e-mail address of the intended recipient at the second client (recipient) machine 19. Because this prior e-mail address of the intended recipient is no longer valid due to the unknown address name, the original e-mail server 20 is unable to resolve the intended recipient e-mail address provided in the e-mail. Using standard electronic mail protocol, the original e-mail server 20 (or a mail sub delivery subsystem) generates an error message (a reply message to the initial e-mail) and transmits the error message to the outgoing e-mail (sender) server 16 (incoming e-mail server thereof), as indicated in step 260. This error message will list the address that was undeliverable (prior e-mail address) and in this case will indicate that the e-mail could not be delivered because the prior e-mail address is no longer a valid address. This delivery of the error message to the outgoing e-mail (sender) server 16 is represented in FIG. 1 by the arrow B.

At step 270, the incoming e-mail (sender) server 16 receives the error message from the original incoming e-mail server 20 and using standard software, the incoming e-mail (sender) server 16 parses or otherwise evaluates the error message to determine the nature of the error message (e.g., was the error due to a bad domain or bad name). In this way, the incoming e-mail (sender) server 16 can determine whether the e-mail to the intended recipient contained an invalid domain or an invalid name in the domain address.

At step 280, in the event that the incoming e-mail (sender) server 16 determines that the prior e-mail address included in the initial e-mail is invalid, the initial e-mail in its original condition is forwarded to the DB+FS 170. The initial e-mail may be forward first from the incoming e-mail server 16 to the outgoing e-mail server 14 before then being delivered to the DB+FS 170. While for the purpose of illustration, the present system will be described in terms of the incoming e-mail (sender) server 16 receiving a “bad name” type error message, it will be understood that the incoming e-mail (sender) server 16 will also cause the initial e-mail message to be delivered to the DB+FS 170 if it receives a “bad domain” type error message from the outgoing e-mail server 20 of the first server 14. This action is accomplished using the software module 180 that in response to receipt of an undeliverable type e-mail notification (e.g., error message B) from any mail server, automatically delivers the undeliverable initial e-mail to the DB+FS 170. The forwarding of the initial e-mail to the DB+FS is represented in FIG. 2 by the arrow C. Because the e-mail is forwarded in its initial state, the recipient address continues to point to the prior e-mail address at the original e-mail server 20.

At step 290, the DB+FS 170 receives the initial e-mail and processes the initial e-mail in accordance with at least one prescribed criterion. For example, in one exemplary embodiment, the DB+FS 170 reads the intended recipient's e-mail address included in the initial e-mail and then compares this e-mail address to a master global e-mail database to see if there is a match. The master global e-mail database is constructed so that it includes a variety of information and customized settings, as will be described in greater detail. At a minimum, the master global e-mail database maintains defunct e-mail addresses for its subscribers/users or users together with an updated, current e-mail address for each such subscriber/user. For example, and in accordance with one embodiment, the second user (intended recipient) has previously notified the DB+FS 170 in any conventional manner that a given e-mail address is not longer active/valid and that a new e-mail address should be used. This information is entered into the master global e-mail database of the DB+FS 170.

Referring to FIGS. 2-5. If after searching the database, the DB+FS 170 does not find the prior e-mail address of the intended recipient, then at step 300, other alternatives, including more conventional methods of correcting an e-mail address may be taken. If the DB+FS 170 can not locate the prior e-mail address in the database, the DB+FS 170 on its own or working in concert with the module 180 can send a command to the original incoming e-mail (recipient) server 20 directing the outgoing e-mail (sender) server 22 to now communicate the error message B to the first user. In this situation, the first user will simply get the error message alerting the first user that the initial e-mail could not be delivered because of an invalid recipient address and thus the operation of the DB+FS 170 would be transparent to the first user. It will also be appreciated that the DB+FS 170 can be constructed so that the DB+FS 170 directly sends a notification message to the sender at the first computer 12 through the incoming e-mail (sender) server 16 indicating that the e-mail was not delivered for specified reasons after a search attempt was made (no record). The DB+FS 170 and the local software 180 can be constructed so that a user can communicate, control and configure these components using any number of appropriate means, including e-mail messages, web site control, or other direct communication. If after searching the database, the DB+FS 170 finds the prior recipient e-mail address in its database of defunct e-mail addresses, the DB+FS 170 will then look-up the current e-mail address for that intended recipient. After the DB+FS 170 has located a current e-mail address for the intended recipient, at step 310, the DB+FS 170 will determine according to a number of criteria whether the initial e-mail should be readdressed and sent to the current e-mail address of the intended recipient at the current (new) incoming e-mail server (recipient) 160. For example, the DB+FS 170 can obtain various criteria from the intended recipient from a web page that includes, for example, a form through which that user, e.g., the intended recipient, enters personalized settings. One exemplary setting is a query function in which the intended recipient may select an “on demand” setting or an “automatic” setting. When the intended recipient has selected the on demand setting, the DB+FS 170 is authorized to notify the intended recipient at his/her current e-mail address of all e-mails that the DB+FS 170 has received which were addressed to the now defunct, prior e-mail address.

The DB+FS 170 will send a notification message to the current e-mail address at the current (new) incoming e-mail server (recipient) 160. The notification message will include various information and at the very least the notification message will indicate that the e-mail message had been addressed to the prior e-mail address and will list the sender's e-mail address. It will be appreciated that the notification message may be constructed to also include the title or subject of the initial e-mail and the time and date which the e-mail was sent. The notification message can include an interactive dialog box that permits the intended recipient to select whether the initial e-mail should be forwarded to the current e-mail address at the current (new) incoming e-mail server (recipient) 160. The dialog box may simply consist of interactive yes and no buttons. Alternatively, the initial e-mail message can be included as part of the notification message.

If the intended recipient commands the DB+FS 170 not to deliver the initial e-mail to the current e-mail address, then at step 320, the DB+FS 170 will inform the sender that the initial e-mail was not delivered to the intended recipient. This may be achieved in a number of ways. For example, the DB+FS 170 may communicate with the outgoing e-mail (sender) server 14 and instruct the outgoing e-mail (sender) server 14 to forward the error message from the original outgoing e-mail server 22 to the incoming e-mail (sender) server 16. Alternatively, the DB+FS 170 may send the notification message directly to the sender e-mail address advising the sender that it has checked the master database and can provide no forwarding information. Optionally, the DB+FS 170 can advise the sender that the intended recipient has set a filter to block certain e-mail. In any event, the current e-mail address of the intended recipient is not revealed to the first user (sender). Thus, the DB+FS 170 can act as a filter through which the intended recipient can automatically and proactively have the origin of all e-mails received at the DB+FS 170 be reviewed prior to deciding if such e-mails should be forwarded to his/her current e-mail address.

In another aspect, the DB+FS 170 may include a setting in which the intended recipient, preferably through an interactive web page, may input a list of anticipated sender addresses that are screened before any message is sent to the intended recipient. This permits the intended recipient to enter sender addresses that are disfavored and should be automatically blocked. The DB+FS 170 will then look at the option settings inputted by the intended recipient and if the sender address is included in the list of disfavored sender addresses, the DB+FS 170 will automatically notify such senders by the methods discussed previously that the initial e-mail was not delivered. Thus, in this aspect of the invention, the intended recipient will not receive any forwarded e-mail from senders that are disfavored by the intended recipient. This feature thus provides an “unwanted message filter” in which the intended recipient may block certain e-mails without having to change e-mail addresses or service providers. This list may be continuously updated over time as needed.

The DB+FS 170 as a recipient protective filter can be used to initiate other automated services and functions including, but not limited to, virus screening, “SPAM” protection, inappropriate material screening, etc.

The DB+FS 170 as a sender protective filter can act as a corporate sentry to limit the non-work related utilization of the corporate network resources by restricting the allowable domain recipients or restricting based on any other desired criteria.

In another aspect of step 310, if the intended recipient has selected the automatic setting, each and every email which the DB+FS 170 receives addressed to the prior e-mail address will be re-addressed and forwarded to the current e-mail address at the current (new) incoming e-mail server (recipient) 160.

At step 330, the initial e-mail is re-addressed by the DB+FS 170 and then forwarded to the current e-mail address at the current (new) incoming e-mail server (recipient) 160 using standard Internet mail protocols. This step is generally illustrated in FIG. 2 with a directional arrow labeled D. At step 340, the DB+FS 170 sends a change of address notification message to the sender e-mail address at the incoming e-mail (sender) server 16. This message will notify the sender that an address change has occurred and will include the current valid e-mail address of the intended recipient. When the incoming e-mail (sender) server 16 receives this e-mail message, the software module 180 thereof preferably permits the sender to update a personalized e-mail address book associated with the sender's e-mail software by adding the current e-mail address as shown in step 350. In addition, the software module 180 may be designed so that when the sender adds the current e-mail address to the address book, the prior invalid e-mail address is deleted therefrom

Preferably, a billing step is included in the network 100 according to one embodiment and as alternatively set forth in steps 360 and 370, either or both the sender and recipient may be charged for the routing feature of the present invention. For example, if the billing is recipient based, the recipient can initially be apprized of the cost when the recipient decides to enroll in the DB+FS service and enter the respective information into the database contained therein. It is within the scope of the present invention, that any number of billing schemes may be developed and implemented.

In another aspect of the present invention, the option settings of the DB+FS 170 may be configured by the intended recipient so that the DB+FS 170 automatically forwards any e-mail to the current (new) incoming e-mail server (recipient) 160 if the sender address is included in an address book entered into the DB+FS 170 by the intended recipient. In other words, this feature permits e-mails to be selectively automatically forwarded if the intended recipient has previously marked this particular sender address as having preferred status. These addresses can be extracted from a conventional address book program such as Internet Explorer from Microsoft Corporation, Redmond, Wash. If the DB+FS 170 cannot locate the sender address in the address book of the intended recipient, the DB+FS 170 will then preferably default to the on demand feature and notify the intended recipient at the current (new) incoming e-mail server (recipient) 160 that an email has been received from a specified sender address. This feature may be used in combination with the previously described blocking feature in which the DB+FS 170 also scans a blocking sender address list entered by the intended recipient. Whether the sender address is found or not in the preferred address book and is in the blocking address book, the DB+FS 170 will automatically not forward or contact the intended recipient concerning the receipt of this e-mail.

In yet another aspect of the present invention, the DB+FS 170 is optionally designed to having a timing mechanism so that if the intended recipient fails to respond to the DB+FS 170 within a predetermined period of time after receiving notification that the initial e-mail has been received, the DB+FS 170 will automatically discard the initial e-mail and then preferably notify the sender that the e-mail was not delivered and this notification may include a statement as to why the e-mail was not delivered.

The DB+FS 170 may also be configured so that it includes another setting identified as a confidential forward function. Preferably, this is part of the on-demand function previously discussed and therefore will be provided in the form of an interactive button in the dialog box in addition to the yes and no interactive buttons. After having received the notification that an e-mail has been received and after knowing the sender address, the intended recipient may wish to receive the initial e-mail so as to be able to fully read the contents thereof, however, the intended recipient does not want the sender to be apprized of the current e-mail address of the intended recipient. If this is the case, the intended recipient simply clicks on the confidential forward function and the initial e-mail is forwarded to the intended recipient. This function permits the intended recipient to read the contents of selected e-mails without automatically notifying the sender of the address change. As an adjunct to the confidential forward function, both senders and recipients could establish coded aliases that would alert the recipient to accept the mail in spite of other blocking restrictions that had been previously been enabled.

One of skill in the art will appreciate that the present system and method account for multiple address changes in that the system has the ability to “daisy-chain” the recipient's addresses if there has been more than one change to get to the most current address. For example, assume that the recipient's e-mail account at the current (new) incoming e-mail server (recipient) 160 becomes no longer active for any number of reasons and that a current e-mail address is maintained at a new e-mail server (not shown). Further, assume these changes can be maintained by the DB+FS 170 database so that when a sender tries to send an e-mail to a prior e-mail address, the DB+FS 170 will then search the database and determine that a change has been made. The DB+FS 170 will first determine that the prior e-mail address at the original e-mail server 150 is invalid (defunct) and was updated with the e-mail address at the e-mail server 160. The DB+FS 170 will then search the database to see if this updated e-mail address at the e-mail server 160 appears as an invalid (defunct) address. In this example, the intended recipient has notified the DB+FS 170 that the e-mail address at the e-mail server 160 is likewise invalid and has been updated with a new e-mail address at the new e-mail server (not shown). The DB+FS 170 will then search the database to make sure that this new e-mail address does not appear therein as being an invalid address. Once the DB+FS 170 determines that this new address is the most updated current address, the DB+FS 170 will continue the routing process and use this new e-mail address in the forwarding process. So long as the intended recipient has entered all successive e-mail address changes into the database, the DB+FS 170 is capable of forwarding the initial e-mail to a current, valid e-mail address no matter how outdated the recipient e-mail address included in the initial e-mail message.

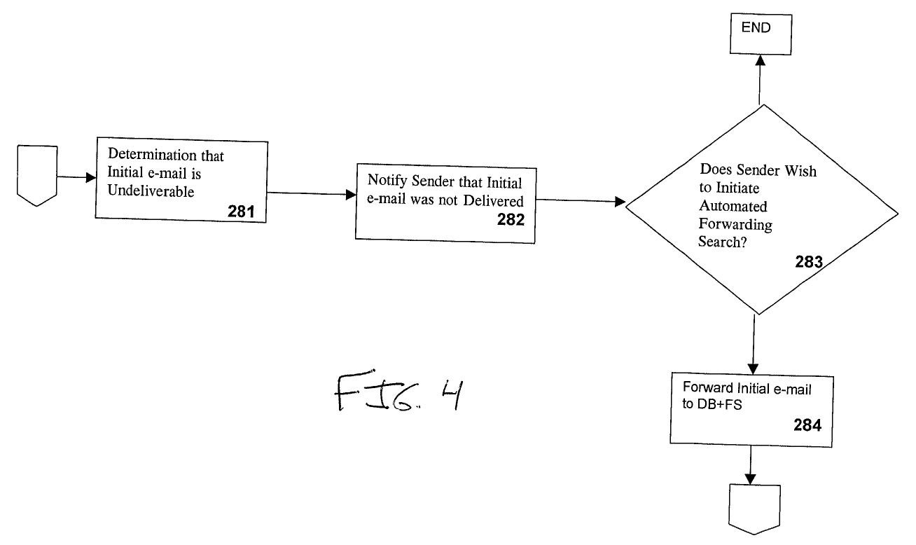

Now referring to FIG. 4 in which the system and method set forth in FIGS. 2 and 3 are modified according to another embodiment of the present invention. In this embodiment, step 280 of FIG. 3 is eliminated and replaced with several other steps. More specifically, and after step 270, the software module 180 of the incoming e-mail (sender) server 16 determines at step 281 that the initial e-mail message is of an undeliverable type. At step 282, the incoming e-mail (sender) server 16 notifies the sender at the first client (sender) machine 12 that the initial e-mail was undeliverable. At step 283, a query is generated by the incoming e-mail (sender) server 16, preferably by, the software module 180. The sender is asked whether he/she wishes to initiate an automated forwarding search using the DB+FS 170. If the sender elects not to initiate such a search, the process ends. If the sender does elect to initiate the search, the sender will command the software module 180 to initiate the search by sending the initial e-mail to the DB+FS 170 with a request command to begin the search. In this step 284, the sender may complete a form provided as part of an interactive dialog box. The form may request certain information and if the present system is designed so that the sender is charged for such a service, the sender may be asked to enter certain billing information at this step. It will be appreciated that a variety of billing plans may be available for the user to select. For example, the sender may elect to pay only per individual e-mails or the sender may enroll in a monthly program that permits unlimited searching capabilities. In the event that the sender elects a plan which includes unlimited searching, the software module 180 will store this information and then whenever, the software module 180 processes an undeliverable e-mail, the incoming e-mail (sender) server 16 will automatically forward the e-mail message without having to initiate the query of step 283. In other words, the sender will not be asked each time if the sender wishes to initiate a search but rather the search is automatically initiated.

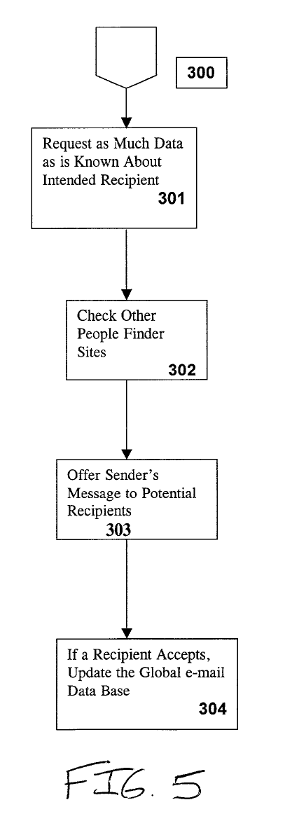

Referring now to FIGS. 2 and 5 in which the alternative measures of step 300 (FIG. 2) are further illustrated. In this situation, the prior e-mail address is not included in the DB+FS database. Once a message is sent from the DB+FS 170 to the incoming e-mail (sender) server 16 indicating that the e-mail address is not found in the database, the software module 180 initiates a process of requesting the sender to provide more information about the intended recipient. At step 301, the sender is requested to enter information about the intended recipient. This may be achieved by completing a form (i.e. web page) in which certain fields are completed. For example, the sender may be asked to input the intended recipient's full name and residential address or at least the city and state. Other information may also be entered which may help to locate the intended recipient. At step 302, the software module 180 initiates a search at suitable people finder sites. For example, there are a variety of host servers which each contain a site dedicated to locating people using search information such as names and residential addresses or even by inputting e-mail addresses. It will also be appreciated that instead of actually initiating searches at these other sites, the software module 180 may provide links instead to these sites so that the sender may easily access these sites and conduct the search directly at the site. At step 303, the initial e-mail may be offered to potential recipients based upon the search results obtained from other people searching sites. For example, if the people search generated a predetermined number of profiles, the sender may select one or more of the profiles and then the incoming e-mail (sender) server 16 will forward the initial e-mail to electronic addresses of these selected individuals. In this step 303, the sender preferably controls whether and to whom the initial e-mail message is forwarded. For example, if the content of the e-mail is of personal and confidential nature, the sender may wish not to send the e-mail to any potential recipient. At step 304, if a potential recipient accepts and replies back to the sender at the incoming e-mail (sender) server 16, the software module 180 is designed to automatically update the address book of the sender by replacing the invalid recipient e-mail address included in the initial email with the reply sender information included in the reply message. The software module 180 also preferably forwards this information to the global database at the DB+FS 170 so that the intended recipient's e-mail address may be updated.

One will also appreciate that the DB+FS 170 may be designed so that when an intended recipient enters an address book into the database of the DB+FS 170, the DB+FS 170 will check within the database to see if any of the inputted addresses are invalid addresses and if so, the invalid addresses will be replaced with the current address. This feature will permit the automatic updating of e-mail mailing lists. For example, one address contained in the intended recipient's address book may be invalid because the DB+FS 170 database has a record that the user of that invalid address has entered a new current address into the same 10 database. The DB+FS 170 could update the address book by inserting this new valid address. Optionally, the DB+FS 170 may generate a notification e-mail which is to be sent to the intended recipient indicating that one or more addresses of the entered address book is invalid and all future communication should be directed to the listed new valid address

The present system provides numerous benefits including, but not limited to, providing the ability to change Internet service providers and/or e-mail addresses without fear of disruption of business or loss of important personal mail, the ability to screen e-mail and enter option settings which automatically either forward messages or return messages based upon sender information included therein, including the sender address, and the ability to purge address lists, replacing obsolete addresses with new ones.

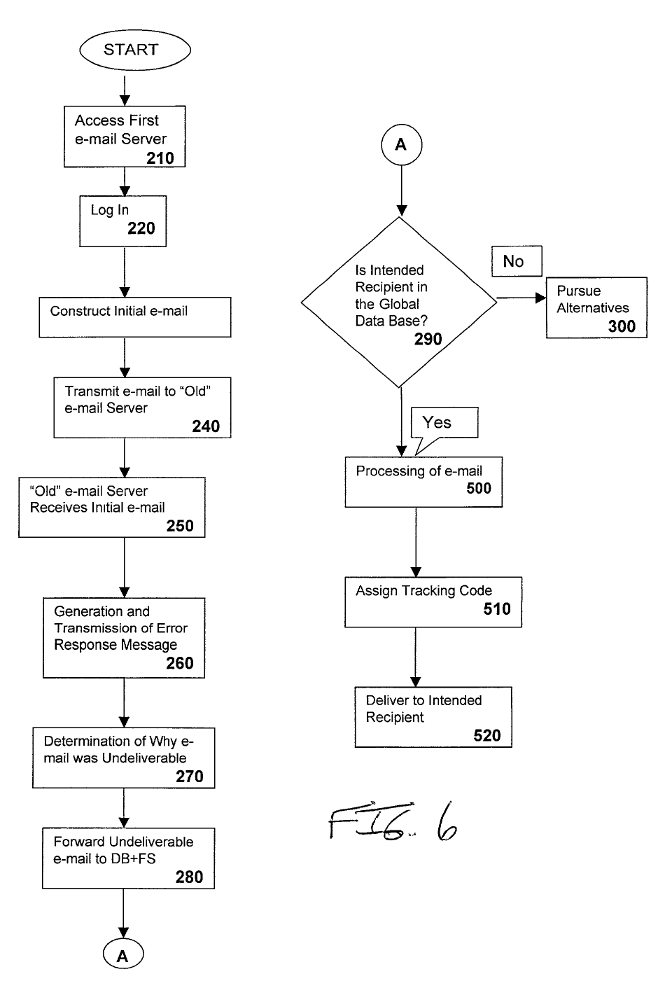

One will appreciate that the present system permits the intended recipient to anonymously reply to the initial e-mail by routing the reply message through the DB+FS 170. This aspect of the invention is presented in FIG. 6 that illustrates this alternative embodiment. In this embodiment, all steps that are identical to previous steps set forth in earlier figures have been labeled using the same reference legends. In the event that the intended recipient is in the global database in the DB+FS 170, the initial e-mail is processed at step 500. Step 500 may contain all of the option capabilities discussed relative to step 310 with the exception being that once the intended recipient commands the DB+FS 170 to deliver the e-mail to the current (new) incoming e-mail server (recipient) 160, the initial e-mail is not readdressed but rather, at step 510, the DB+FS 170 enters a unique tracking code to the routing information set forth in the profile of the e-mail. After the unique tracking code has been assigned, the DB+FS 170 delivers the e-mail, at step 520, to the valid address at the current (new) incoming e-mail server (recipient) 160. However, when the intended recipient replies, the reply message goes to the DB+FS 170 which then reads the unique code and knows to forward the message to sender at the incoming e-mail (sender) server 16. Thus, the sender receives a reply e-mail in which the reply sender information lists only the unique tracking code and does not reveal any personal address information concerning the sender of the reply (the original intended recipient). The DB+FS 170 is thus designed to strip from the initial e-mail all personal address information relative to the intended recipient. Thus, this embodiment provides an anonymous method of replying to the sender of the initial e-mail. One will also appreciate that the system also permits the sender to anonymously send e-mail by routing it through the DB+FS 170.

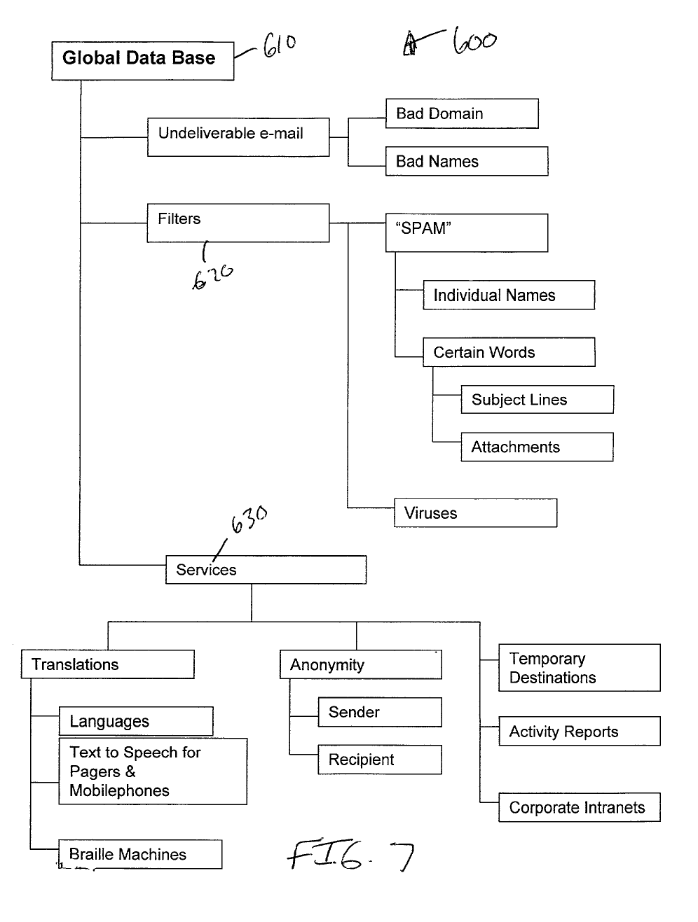

FIG. 7 is a diagramatic illustration of a total e-mail management system, generally indicated at 600. The system 600 includes a global database 610 which is not only arranged to function as the DB+FS but also includes and provides other features such as filters 620 and related services 630, which will be familiar to computer users.

One will understand that the present system may be carried out in a number of different embodiments. For example, the software module 180 may be included as part of a standalone software package (e.g., Microsoft Outlook) that operates independently from other software programs or the software module 180 may be embedded within an e-mail program, or implemented within an e-mail system or browser to enhance its mail messaging capabilities. An alternative embodiment eliminates the automated aspect of the invention and replaces it with a “service fee per activation” approach.

From a logical standpoint it may be preferable that the system be implemented by incorporating the features thereof into the incoming e-mail server associated with the first client (sender) machine 12. In other words, it is this incoming e-mail server which receives the error messages from either the outgoing e-mail server of the same first client (sender) machine 12 or from the outgoing e-mail server associated with the second client (recipient) machine 19. However, the economics of the ultimate business relationship that implements this invention may dictate incorporation in other portions of the “message path”.

One will also appreciate that it is not necessary for the system of the present invention to forward mail or error messages to the DB+FS. The system may interact with the DB+FS in a number of other ways using other interactive systems which may be implemented with the present invention.

It will be understood by those skilled in the art that the terms “machine” and “servers” are conventional euphemisms for mail servers and machines that can be virtual in nature, spanning multiple physical devices and/or multiple instances of software working in concert.

While the invention has been particularly shown and described with reference to the preferred embodiments thereof, it will be understood by those skilled in the art that various changes in form and detail may be made therein without departing from the spirit and scope of the invention.

What is claimed is:

1. A method for routing an otherwise undeliverable e-mail message to an intended recipient, comprising the steps of:
electronically mailing an initial e-mail message from a first machine associated with a sender to an outgoing e-mail processor associated with the first client (sender) machine, the outgoing e-mail processor communicating with a domain name server to check the validity of a domain portion of the e-mail message, and in the event that the domain portion is not valid, the outgoing e-mail processor notifies the first machine of the invalid domain portion;
in the event that the domain portion of the e-mail message is valid, the outgoing e-mail processor forwards the initial e-mail message to an initial e-mail address of the intended recipient at a second machine associated with the intended recipient;
parsing the initial e-mail message at the second machine to determine whether the initial e-mail address remains valid;
in the event that the initial e-mail address is no longer valid, creating an error message at the second machine and forwarding it to an incoming e-mail processor associated with the first machine and then forwarding at least the initial e-mail message to a designated server; and
processing the initial e-mail message at the designated server in accordance with at least one prescribed criterion; the designated server being configured to search for a current e-mail address of the intended recipient and facilitate delivery of the initial e-mail message to the intended recipient, whereby a preferred method for rerouting the undelivered message is determined based on user preference.

2. The method as in claim 1, wherein processing the initial e-mail message includes the steps of:
determining whether a current e-mail address of the intended recipient is included in a master e-mail address database of the designated server; and
in the event that the current e-mail address is included in the database, delivering at least the initial e-mail message from the designated server to the current e-mail address of the intended recipient in accordance with one or more commands provided by the intended recipient.

3. The method as in claim 2, wherein the one or more commands comprises an authorization command by the intended recipient to receive the initial e-mail message.

4. The method as in claim 2, wherein the one or more commands comprise an “on demand” command in which the intended recipient is first notified of the existence of the initial e-mail message and then given the option as to whether the initial email message is to be forwarded to the current e-mail address.

5. The method as in claim 2, wherein processing the initial e-mail message includes the steps of:
sending an e-mail notification to the current e-mail address of the intended recipient indicating receipt of an e-mail addressed to an account associated with the second machine; and
receiving a reply authorization message at the designated server, the reply authorization message providing a command for the designated server to deliver the initial message to the current e-mail address and to deliver an electronic notification message to the first computer notifying the sender of the current e-mail address of the intended recipient.

6. The method as in claim 3, including the additional step of:
providing the sender at the first computer with an opportunity to automatically add the current e-mail address of the intended recipient to an address book of the sender.

7. The method as in claim 6, including the additional step of: deleting the initial e-mail address from the address book of the sender.

8. The method as in claim 2, wherein the processing of the initial e-mail message further includes the step of:
reviewing option settings entered into the designated server by the intended recipient; and in the event that one of the active option settings is an automatic forwarding setting, sending the initial e-mail message automatically to the current e-mail address and automatically notifying the sender at the first computer of the current e-mail address of the intended recipient.

9. The method as in claim 1, further including the steps of:
delivering and storing at the designated server an electronic address book of the intended recipient;
and wherein the processing of the initial e-mail message includes the step of:
determining whether an e-mail address of the sender is included in the electronic address book and in the event that the sender e-mail address is included in the address book, automatically delivering the initial e-mail message to a current e-mail address of the intended recipient at the second computer and notifying the sender at the first computer of the current e-mail address.

10. The method as in claim 1, further including the steps of:
delivering and storing at the designated server an electronic address book of the intended recipient, the address book containing a list of one or more blocking addresses; and
wherein the processing of the initial e-mail message includes the step of:
determining whether an e-mail address of the sender is included in the list of one or more blocking addresses and in the event that the sender e-mail address is included in the list, automatically returning the initial e-mail message to the sender at the first machine, thereby prohibiting the initial e-mail message from being delivered to a current e-mail address of the intended recipient.

11. The method as in claim 1, wherein the identity of the current e-mail address is shielded from the sender.

12. The method as in claim 1, wherein the initial e-mail message is delivered from the outgoing e-mail processor at the first client (sender) machine to an incoming e-mail processor at the second client (recipient) machine, the incoming e-mail processor determining whether an address name portion of the e-mail address is valid.

13. The method as in claim 12, wherein the incoming e-mail processor of the second client (recipient) machine sends an error message to the incoming e-mail server of the first client (sender) machine.

14. The method as in claim 2, wherein processing the initial e-mail message includes the steps of:
notifying the sender that the initial e-mail message was undeliverable in the event that the current e-mail address is not included in the database; and
providing the sender with an option of initiating a search for the current e-mail address of the recipient using search engines other than the designated server, in the event that the sender elects such option, connecting the sender to one or more alternative search engines.

15. The method as in claim 14, further including the step of:
in the event that the sender elects to initiate the search, requesting the sender to provide background information about the intended recipient, including one or more identifiers selected from the group consisting of full name, full residential address, city and state of residence, and place of employment.

16. The method as in claim 1, wherein processing the initial e-mail message includes the steps of:
determining whether a current e-mail address of the intended recipient is included in a master e-mail address database of the designated server; and
in the event that the current e-mail address is included in the database, sending an e-mail notification to the current e-mail address;
delivering the initial e-mail message to the current e-mail address in accordance with an anonymous mail command provided by the intended recipient to the designated server, whereby the designated server enters a unique tracking code into routing information contained in a profile of the initial e-mail message and then delivers the initial email message to the current e-mail address, the unique tracking code being maintained in the routing information such that a reply e-mail created by the intended recipient is delivered to the designated server which reads the tracking code and then forwards the reply e-mail to the sender, the sender receiving the reply e-mail which only lists the unique tracking code with the current e-mail address of the intended recipient being absent from routing information of the reply e-mail.

17. A method for routing an otherwise undeliverable e-mail message to an intended recipient, comprising the steps of:
electronically transferring an initial e-mail message from a first machine associated with a sender to a first outgoing e-mail processor associated with the first client (sender) machine, the initial e-mail message including an initial e-mail address formed of a domain portion and a name address portion;
checking the validity of the domain portion with a domain name server in communication with the first outgoing e-mail processor and in the event that the domain portion is invalid, sending a first error message to an outgoing e-mail processor of the first client (sender) machine;
in the event that the domain portion of the e-mail address is valid, the first outgoing e-mail processor forwards the initial e-mail message to the initial e-mail address of the intended recipient at a second machine associated with the intended recipient;
parsing the initial e-mail message at an incoming e-mail processor associated with the second machine to determine whether the name address portion is valid;
in the event that the name address portion is no longer valid, notifying the sender that the initial e-mail message is undeliverable and providing the sender with an option of initiating a search for a current e-mail address of the intended recipient;
in the event that the sender elects to initiate the search, forwarding at least the initial e-mail message to a designated server; and
processing the initial e-mail message at the designated server in accordance with at least one prescribed criterion, whereby a preferred method for rerouting the undelivered message is determined based on user preference.

18. The method as in claim 17, wherein processing the initial message includes the steps of:
determining whether a current e-mail address of the intended recipient is included in a master e-mail address database of the designated server; and
in the event that the current e-mail address is included in the database, delivering at least the initial e-mail message from the designated server to the second computer in accordance with one or more commands provided by the intended recipient.

19. The method as in claim 17, further including the step of:
providing a billing request form for completion by the sender if the sender elects to initiate the search at the designated server, the billing request form having payment options for conducting the search.

20. A method for determining a current e-mail address of an intended recipient prior to sending message, comprising the steps of:
electronically transferring an e-mail validation request from a first machine associated with a sender to a first outgoing e-mail processor associated with the first client (sender) machine, the e-mail validation request including at least an initial e-mail address formed of a domain portion and a name address portion;
checking the validity of the domain portion with a domain name server in communication with the first outgoing e-mail processor and in the event that the domain portion is invalid, sending a first error message to an outgoing e-mail processor of the first client (sender) machine;
in the event that the domain portion of the e-mail address is valid, the first outgoing e-mail processor forwards the e-mail validation request to the initial e-mail address of the intended recipient at a second machine associated with the intended recipient;
parsing the initial e-mail validation request at an incoming e-mail processor associated with the second machine to determine whether the name address portion is valid, in the event that the name address portion is valid, notifying the sender that the initial e-mail address is valid, and in the event that the name address portion is no longer valid, forwarding the e-mail validation request to a designated server; and
processing the e-mail validation request at the designated server in accordance with at least one prescribed criterion, the designated server being configured to search for a current e-mail address of the intended recipient and selectively notify the sender of the current e-mail address based upon the at least one prescribed criterion.
